(19) United States
(12) Patent Application Publication
(10) Pub. No.: US 2024/0391042 A1
(43) Pub. Date: Nov. 28, 2024

(54) Grinding machine and method for operating a grinding machine

(71) Applicant: ADELBERT HAAS GMBH, Trossingen (DE)

(72) Inventors: Gerhard SCHNEE, Denkingen (DE); Dirk WEMBER, Rottweil (DE)

(21) Appl. No.: 18/668,844

(22) Filed: May 20, 2024

(30) Foreign Application Priority Data
May 23, 2023 (DE) 102023113408.6

(51) Int. Cl. B23Q 7/04

(52) U.S. Cl. CPC B23Q 7/046

(57) ABSTRACT

A grinding machine includes a machine bed on which a workpiece spindle with a workpiece holder and a tool spindle with a tool holder are arranged in such a way that a workpiece held in the workpiece spindle can be moved or rotated along several axes relative to a tool held in the tool holder. A cabin is arranged on the machine bed which defines a working space in which the tool spindle and the workpiece spindle are arranged for machining workpieces. The grinding machine has a robot for changing the workpiece, which is arranged outside the work area in an automation cabin. The grinding machine has a light barrier enclosing the X-axis with a transmitter and at least one receiver for determining the unclamping length of the workpiece in the workpiece spindle when the workpiece spindle is moved back from the automation cabin after the workpiece change.

The invention relates to a grinding machine with the features of the preamble of claim 1, and a method for operating such a grinding machine.

Grinding machines, such as those known from EP 2 915 622 B1, enable workpieces to be machined, which is characterized by the fact that they can be used to produce complex surface geometries with high precision. Precisely because this high-precision production requires considerable processing time in many cases, it is particularly important to achieve the highest possible throughput of workpieces in order to be able to manufacture cost-effectively and profitably.

DE 10 2022 112 353 discloses a grinding machine in which a cabin is arranged on the machine bed, which defines a work area in which in particular the tool spindle and the workpiece spindle for machining workpieces are arranged, the grinding machine having a robot for changing workpieces, which is arranged outside the work area in an automation cabin, wherein the workpiece spindle can be moved to the automation cabin or into the automation cabin on the X-axis for a workpiece change, so that the robot arm does not reach into the work area when changing the workpiece. After a workpiece change, the unclamping length of the corresponding workpiece must be determined before each machining of the workpiece in order to ensure high machining accuracy. It is known to scan the clamped workpiece with a mechanical probe as soon as the workpiece spindle has moved back to a machining position after the workpiece has been changed in order to determine the unclamping length. The unclamping length can in particular be considered the length of the workpiece that protrudes beyond the workpiece holder, or the distance between the support surface of the workpiece spindle and the free end of the workpiece held in the workpiece spindle.

It is the object of the invention to further develop a grinding machine and a method for operating a grinding machine in such a way that the throughput that can be achieved with the grinding machine is increased.

This object is achieved by a grinding machine with the features of claim 1 and a method for operating a grinding machine with the features of claim 10.

Advantageous configurations and refinements of the invention are the subject of the respective dependent claims.

The grinding machine according to the invention has a machine bed on which a workpiece spindle with a workpiece holder and a tool spindle with a tool holder are arranged in such a way that a workpiece held in the workpiece spindle, relative to a tool held in the tool holder, preferably a grinding tool, which can be formed, in particular, by a grinding wheel pack, is
displaceable along an X-axis, which is an axis running in a first direction parallel to the surface of the machine bed,
displaceable along a Y-axis, which is an axis running in a second direction parallel to the surface of the machine bed,
displaceable along a Z-axis, which is an axis running perpendicular to the surface of the machine bed,
rotatable about an A-axis, which is an axis running parallel to the surface of the machine bed, and
rotatable about a C-axis, which is an axis running perpendicular to the surface of the machine bed.

The grinding machine further comprises a cabin arranged on the machine bed, which defines a work area, in which in particular the tool spindle and the workpiece spindle are arranged for machining workpieces.

Finally, the grinding machine has a robot, which can be embodied, in particular as a robot arm, for changing workpieces, which is arranged outside the work area in an automation cabin, which can, however, be opened in particular in the direction of the work area at least temporarily, in particular for the tool change, wherein the workpiece spindle can be moved on the X-axis to the automation cabin or into the automation cabin so that the robot does not have to reach into the work area when changing the workpiece.

It is essential to the invention that a light barrier with a transmitter and at least one receiver is provided for determining the unclamping length of the workpiece in the workpiece spindle when the workpiece spindle is moved back from the automation cabin after the workpiece change. The light barrier, in particular the light beam of the light barrier, crosses in particular the X-axis and is particularly preferably arranged perpendicular to it. First, such an optical measuring method enables contactless measurement of the workpiece. Furthermore, this light barrier enables the unclamping length to be determined in a simple manner directly by moving the workpiece spindle on the feed path from the position of the workpiece spindle in which the workpiece change takes place to the machining position in the work area. Additional time required to determine the unclamping length when the workpiece spindle has moved to the machining position in the work area is therefore completely eliminated, since the determination of the unclamping length takes place during the time already required to move the workpiece spindle from the changing position to the machining position. In this way, the throughput that can be achieved with the grinding machine can be significantly increased.

The transmitter is preferably designed as a laser, which means that a high degree of accuracy can be achieved in determining the position in which the light barrier is released.

A particularly advantageous embodiment of the invention provides that the transmitter and the receiver are arranged on a measuring bridge which encloses the X-axis. By using such a measuring bridge, the transmitter and the receiver are already aligned and adjusted relative to one another, which can simplify installation. The transmitter and the receiver can be arranged to be displaceable on the measuring bridge in order to be able to align or finely adjust them relative to one another if necessary.

Preferably, the measuring bridge is arranged to be displaceable in the direction perpendicular to the X-axis. This enables easy adjustment if workpieces with different geometries are to be machined in the grinding machine.

The grinding machine advantageously comprises means for electro-optical distance measurement and/or geometric measurement. The means can in particular be designed to be laser-based and based, for example, on a transit time measurement, a phase position measurement or the principle of laser triangulation. The means are in particular arranged in such a way that the measurement can take place at the changing position or on the feed path from the changing position to the processing position. Such means enable the determination of further geometric features of the workpiece, for example the measurement of the diameter or the width of the workpiece, but also the measurement of the conicity or the convexity or other geometric features of the workpiece or the workpiece spindle relative to the workpiece, in particular on the feed path from the change position to the machining position, and thus without loss of time.

The means can be designed as a separate measuring unit in addition to the light barrier. However, a particularly advantageous refinement of the invention provides that the light barrier has two receivers, with the second receiver in particular being arranged on the side of the transmitter and thereby being able to detect the laser beam reflected on the workpiece if the workpiece interrupts the laser beam. This makes it possible to measure not only the unclamping length of the workpiece, but also other geometric features such as the diameter or width of the workpiece with the smallest possible number of components.

The X-axis is advantageously guided through a closable hatch between the cabin and the automation cabin, and the measuring bridge is arranged on the wall between the cabin and the automation cabin, in particular within the automation cabin. Using the closable hatch, the work area and automation room can be separated as best as possible, so that the robot can be kept as much as possible free from dirt. The smaller the hatch, the faster it can be opened and closed, so that the throughput that can be achieved with the grinding machine can be further increased. The hatch is therefore preferably only slightly wider than the workpiece spindle. The arrangement of the measuring bridge on the wall between the cabin and the automation cabin enables reliable and stable fixation. In addition, this arrangement can enable alignment or adjustment of the measuring bridge if necessary. The measuring bridge can also be largely kept free from dirt within the automation cabin.

Preferably, the tool spindle is completely kinematically separated from the workpiece spindle, with movements along the X-axis, about the A axis and about the C axis being carried out by the tool spindle (the axis of rotation of which is typically defined or formed by the A axis), and movements along the Y-axis and along the Z-axis being carried out by the tool spindle. This type of kinematic separation not only allows to improve the precision of the positioning, because an arrangement with three linear axes built onto one another is avoided, but also allows the workpiece and tool to be changed at the same time, so that the workpiece throughput that is achievable with the grinding machine can be increased because the movement necessary for the tool change or for the workpiece change to the change positions to be approached by the tool spindle or workpiece spindle can be carried out simultaneously.

It can be particularly useful for this purpose if the X-axis is extended. This can be achieved in a particularly advantageous manner by arranging an add-on module on the machine bed, which extends the X-axis and carries the automation cabin. The add-on module can also be designed in one piece as an extension of the machine bed beyond the cabin.

According to an advantageous refinement of the invention, a palletizing system or a pallet storage system is present, from which the robot can remove workpiece blanks and in which the robot can place machined workpieces.

In the method according to the invention for operating a grinding machine according to the invention, workpieces clamped at the workpiece spindle are machined successively with one or more grinding tools clamped at the tool spindle. A workpiece change is carried out with a robot arranged outside the work area in an automation cabin by moving the workpiece spindle with the workpiece holder, which is designed, for example, as a clamping system, along the X-axis to the automation cabin or into the automation cabin. Especially when using linear motors and a direct position measuring system, this is faster and more precise than the movement of the robot, which is also protected in this way.

According to the invention, it is provided that after the workpiece change, when the workpiece spindle is moved back from the automation cabin, the unclamping length of the workpiece in the workpiece spindle is determined by means of a light barrier with a transmitter and a receiver by
inserting, when changing the workpiece, the workpiece into the workpiece spindle in such a way that in a change position the workpiece inserted into the workpiece spindle interrupts the light barrier,
determining, when the workpiece spindle is moved back, at which position of the workpiece spindle the light barrier is no longer interrupted
and setting this position in relation to the position of the workpiece spindle in the changing position.

The light barrier is in particular arranged in such a way that the light beam of the light barrier traverses the X-axis and is particularly preferably arranged perpendicular to it.

Such a method enables the unclamping length to be determined in a simple manner directly while the workpiece spindle is moving on the feed path from the position of the workpiece spindle in which the workpiece change takes place to the machining position in the work area. Additional time required to determine the unclamping length when the workpiece spindle has moved to the machining position in the work area is therefore completely eliminated, since the determination of the unclamping length takes place during the time already required to move the workpiece spindle from the changing position to the machining position. In this way, the throughput that can be achieved with the grinding machine can be significantly increased.

Advantageously, after the workpiece change, in particular when the workpiece spindle is moved back from the automation cabin, an electro-optical distance measurement and/or geometric measurement is carried out. The electro-optical measurement or measurement can be laser-based, for example, in particular based on a transit time measurement, a phase position measurement or the principle of laser triangulation. This makes it possible to determine further geometric features of the workpiece, for example measuring the diameter or width of the workpiece, but also measuring the conicity or the convexity or other geometric features of the workpiece or the workpiece spindle relative to the workpiece, in particular on the feed path from the change position to the machining position and thus without loss of time.

The measurement can be carried out using a measuring unit that is available in addition to the light barrier. However, after the workpiece change, when the workpiece spindle is moved back from the automation cabin, preferably, a further geometric feature such as the diameter or width of the workpiece, the conicity or the convexity of the workpiece or the relative position of the cooling channel of the workpiece spindle relative to the workpiece is determined by means of the light barrier, by determining the transit time, the phase position and/or the angle of the laser beam reflected on the workpiece when the light barrier is interrupted by the workpiece. This allows additional measurement of the workpiece to be carried out on the feed path.

According to an advantageous refinement of the invention, when changing the workpiece, it is monitored whether the workpiece inserted into the workpiece spindle interrupts the light barrier by the workpiece in the changing position, and an alarm signal or an error message is output if the light barrier is not interrupted. This makes it easy to check whether the workpiece is changed correctly and the workpiece is inserted into the workpiece holder.

Preferably, in order to carry out a workpiece change and/or to carry out a tool change, the workpiece spindle and/or the tool spindle are moved kinematically decoupled from one another, which makes it possible to simultaneously send both the workpiece spindle and the tool spindle to their respective setup position, at which they are loaded or their loading is customized adjusted.

In particular, the robot and the work piece spindle can be pre-positioned so that to specify the machined work piece and/or to take over the new work piece, in particular as a blank, only a movement along the X-axis has to be carried out, so that the work piece spindle with the clamping system forming the workpiece holder, and the workpiece can be moved into the automation cabin immediately after machining. In this case, before reaching the automation cabin, the A-axis can be aligned parallel or at a defined angle to the X-axis by rotating it about the C-axis.

Because the control of the X-axis works with high precision and with greater precision than that of the robot, it is particularly advantageous if, when picking up the next workpiece to be machined, the movement needed for removing the workpiece from the clamping system that forms the workpiece holder of the workpiece spindle, and/or for inserting the next workpiece into the clamping system that forms the workpiece holder of the workpiece spindle, in the direction of the X-axis takes place by displacing the workpiece spindle along the X-axis, in particular after the robot has assumed the correct position relative to the X-axis.

An exemplary embodiment of the invention is explained in more detail below with reference to the following figures, in which

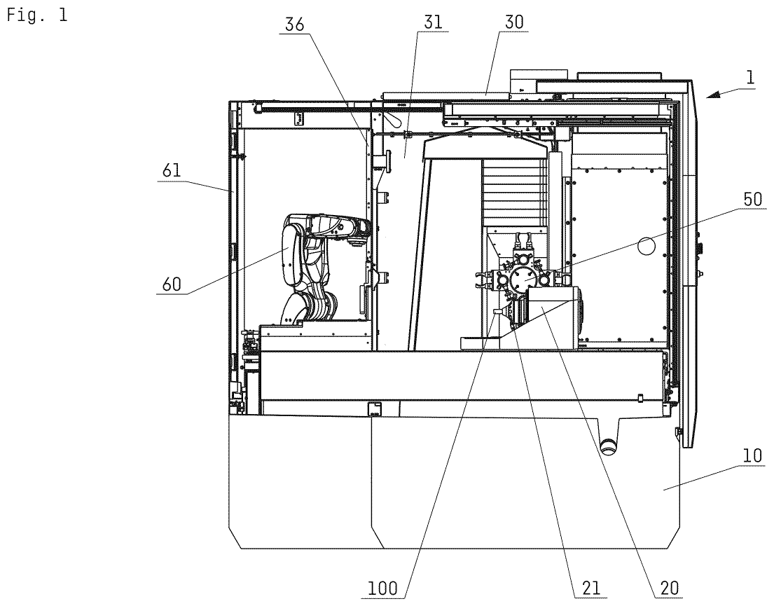

FIG. 1 shows a side view of an exemplary embodiment of a grinding machine according to the invention, in which a side wall is hidden, with a workpiece spindle in a machining position,

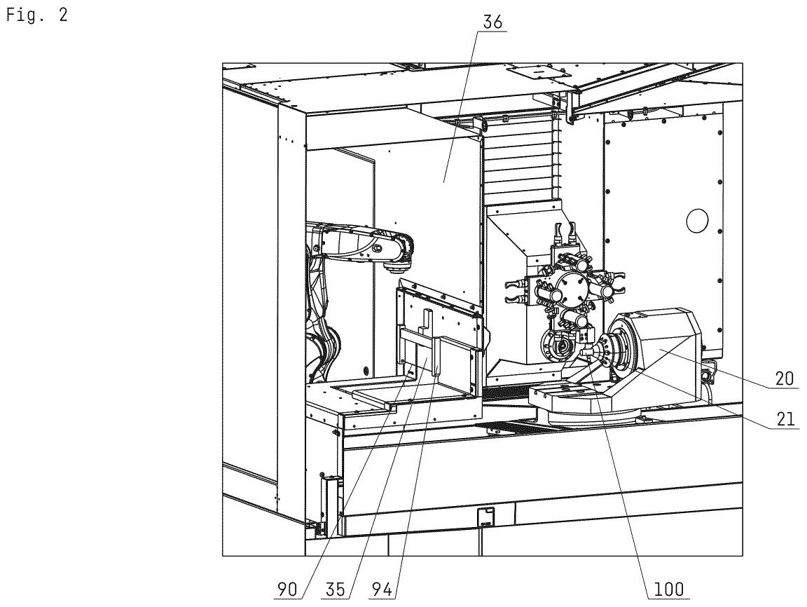

FIG. 2 shows a perspective view of the grinding machine according to FIG. 1,

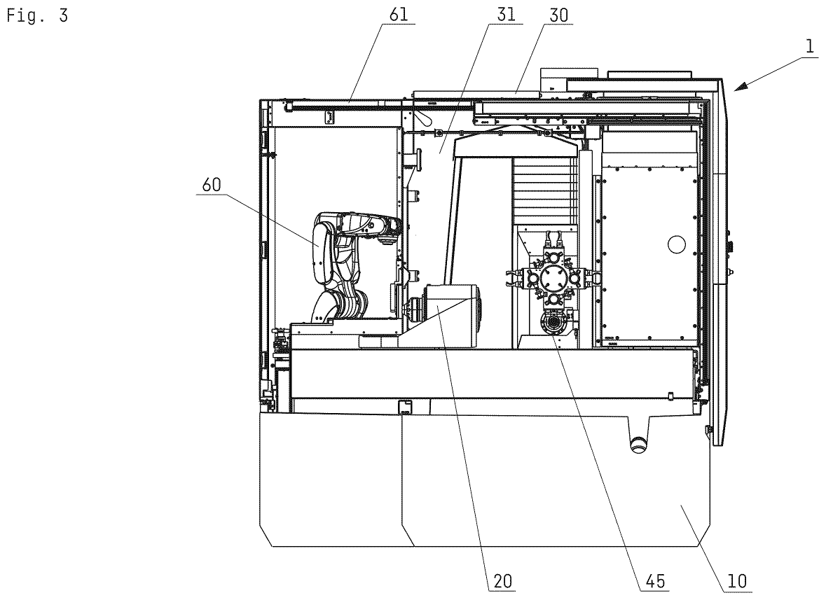

FIG. 3 shows a side view of an exemplary embodiment of a grinding machine according to the invention, in which a side wall is hidden, with the workpiece spindle in a changing position,

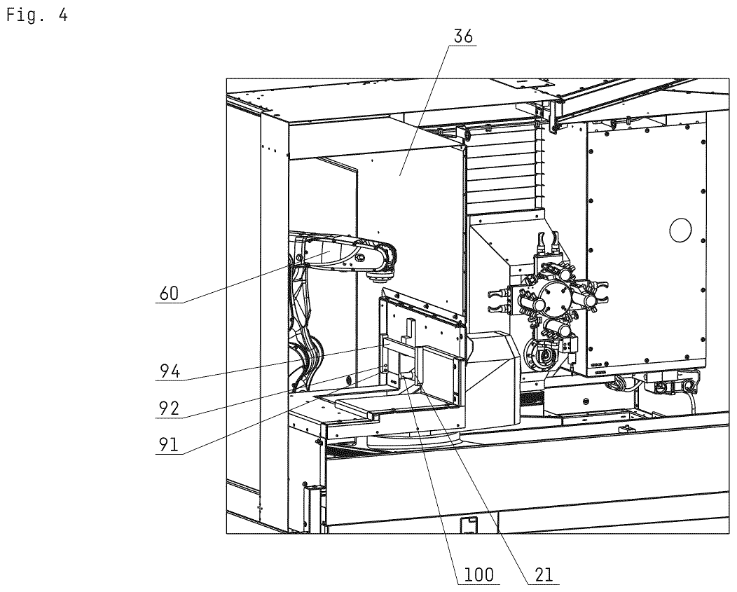

FIG. 4 shows a perspective view of the grinding machine according to FIG. 3,

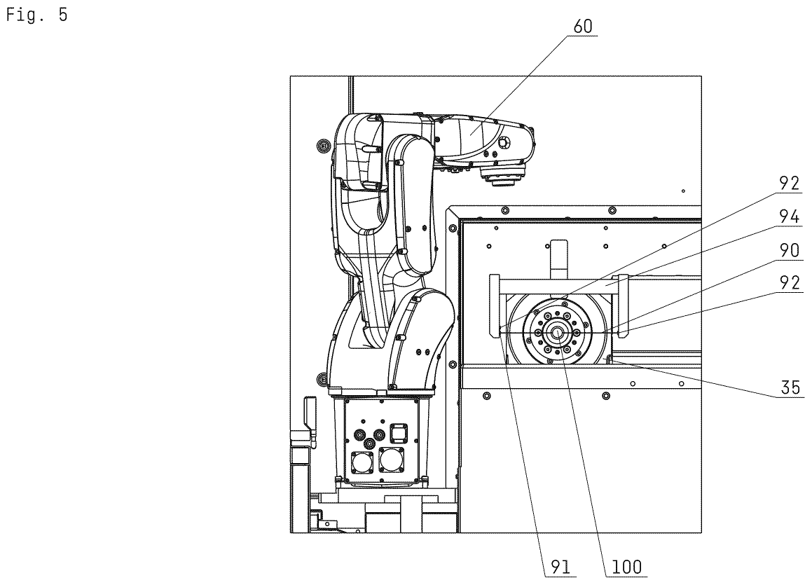

FIG. 5 shows a view along the X-axis of the workpiece spindle of the grinding machine according to FIG. 3,

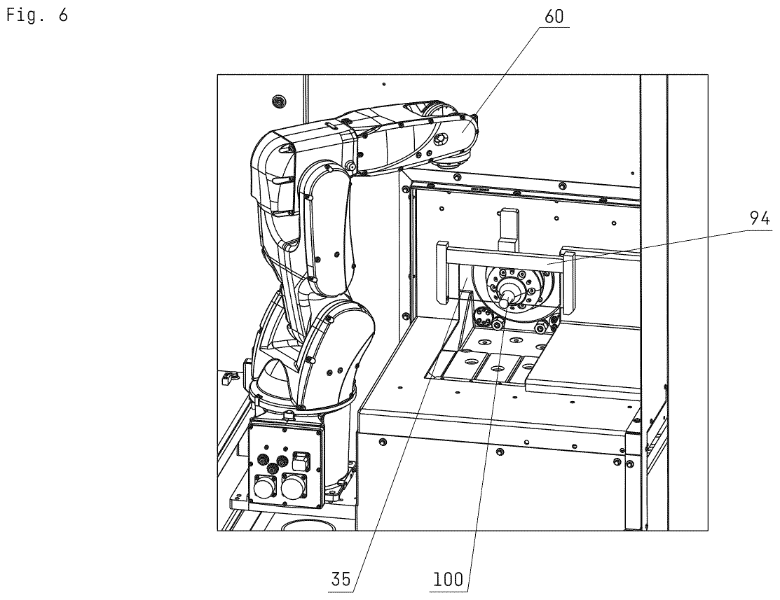

FIG. 6 shows a further perspective view of the grinding machine according to FIG. 3,

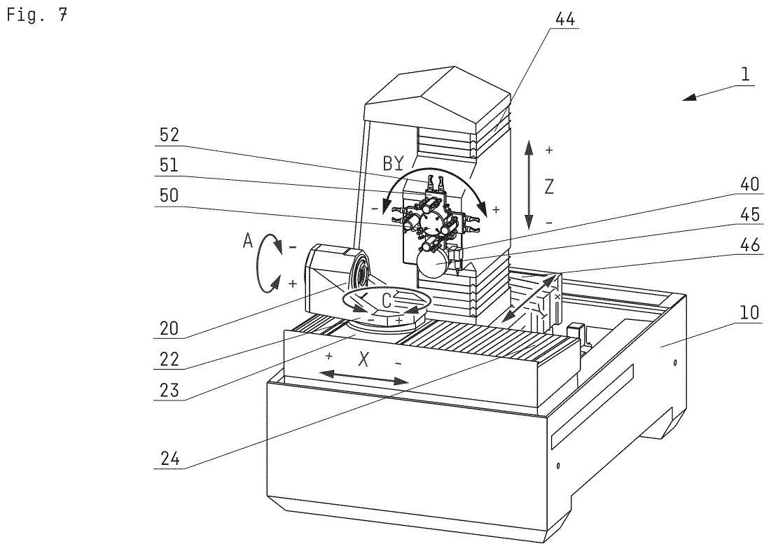

FIG. 7 shows a view of one of the grinding machines according to FIG. 1 with the cabin removed, the automation cabin removed and the workpiece holder removed, and

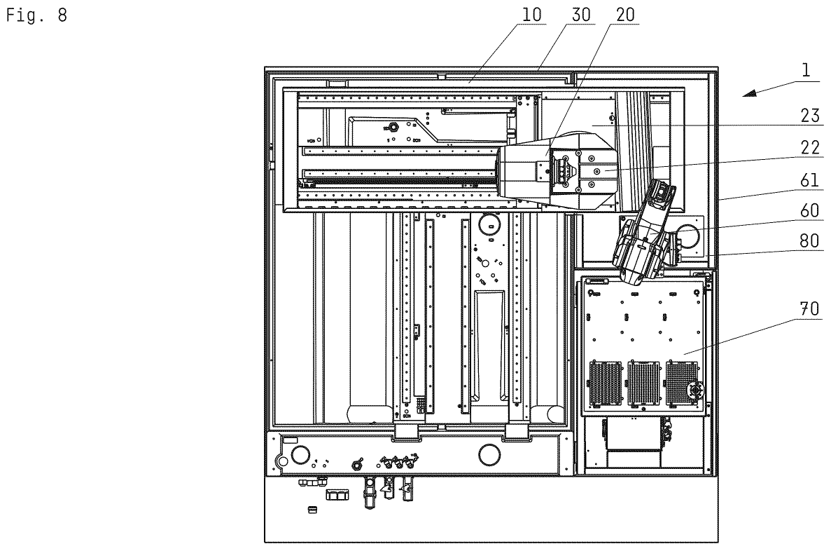

FIG. 8 shows a top view of components of the grinding machine according to FIG. 1.

FIGS. 1 to 8 show different views of an exemplary embodiment of a grinding machine 1 according to the invention, wherein the same reference numerals designate the same or functionally identical parts, but for better clarity not all reference numeral are indicated in all figures.

Grinding machine 1 comprises a machine bed 10, which can be manufactured for the benefit of high accuracy in molding technology using mineral casting for improved vibration damping. The machine bed 10 carries a workpiece spindle 20 with a workpiece holder 21 and a tool spindle 40 with a tool holder 41. Machine bed 10 can also have integrated cable ducts, a gravity-driven drain with an outlet where an optional screen is placed, for coolant and lubricant, integrated pipes for lubrication, motor cooling, process cooling and grounding, and integrated level monitoring, which are not visible in the representation of the figures because they are covered by other components.

Workpiece spindle 20, whose workpiece holder 21 defines the horizontally running A-axis of grinding machine 1, can be integrated in a T-slot table 22, which is designed to be rotatable about the vertically running C-axis and is displaceable horizontally along the X-axis on a carriage 23. Carriage 23 runs in particular on rails which are arranged on machine bed 10, but which in FIG. 7, like the linear motor which drives carriage 23 and the direct, absolute measuring system which monitors its position, are located under a cover 24 and are therefore not visible.

Tool spindle 40, which is shown, for example, with a tool 45 held therein in the form of a grinding wheel pack, can be carried by a carriage 42, which is displaceable along the Z-axis in the vertical direction on a rail system arranged vertically on a further carriage 43, which rail system defines said vertical Z-axis. This rail system as well as the drive and the position monitoring of carriage 43 are not visible in the figures because they are located under a cover 44.

Further carriage 43 in turn runs on rails which are arranged on machine bed 10, and which, in the figures, like the linear motor, which drives further carriage 43 and the direct, absolute measuring system which monitors its position, are located under cover 46 and are therefore not visible. These rails define the Y-axis, which runs perpendicular to the X-axis and is also horizontal.

In this way, in case of grinding machine 1, tool spindle 20 is completely kinematically separated from the workpiece spindle 40, with movements along the X-axis, about the A-axis and about the C-axis being carried out by the workpiece spindle 20 and movements along the Y-axis and along the Z-axis being carried out by tool spindle 40.

Carriage 42 also carries a tool changer 50, which in this case is designed for a total of four tools, but of which only tool 45 that has just been held by tool spindle 40 is shown in the figures, in order to show the setup of tool changer 50 in the figures in more detail.

Tool changer 50, which is, as a result, moved together with tool spindle 40 in the direction of the Y-axis and in the direction of the Z-axis, in the present case has a carrier plate 51 with four arms of equal length arranged in the shape of a cross, at the end of which a gripper 52 can be arranged, which carries a tool 45, in particular a grinding wheel pack, in the equipped state. Carrier plate 51 is rotatable in particular about a driven BY-axis running parallel to the Y axis; moreover, it can be moved in the direction parallel to this axis in the direction towards and back from the viewer in FIG. 7.

This allows tool 45 held by tool spindle 40 during grinding to be gripped with associated gripper 52 when a tool change is necessary and, after the spindle clamp has been released, to lift it parallel to the BY-axis by a linear movement which runs towards the viewer in FIG. 7. Thereafter, tool changer 50 can then be rotated, for example, by 90°, so that the next tool 45 held by gripper 52 of the next arm is positioned so that it is possible that the tool 45 can be inserted parallel to the BY-axis into tool holder 41 of tool spindle 40 by linear motion, which in FIG. 1 is in the direction away from the viewer, to activate the spindle clamp and then release it with gripper 52 in order to be able to continue machining. During machining, this gripper 52 thus remains in a position in which it only has to be closed the next time the tool is changed in order to grip tool 45 to be changed. In this way, a very quick tool change is possible because only minimal travel distances have to be covered.

A cabin 30 is arranged on machine bed 10, which encloses a work area 31, in which in particular tool spindle 40 and workpiece spindle 20 are arranged.

FIG. 8 shows a top view of components of the grinding machine according to FIG. 7 in combination with automation by a robot 60 and a palletizing system 70. The entire structure that carries tool spindle 40 and tool changer 50, as well as the covers 24, 44 and 45 have been omitted, so that additional detail of machine bed 10, in particular the rails that define the X-axis and the Y-axis, can be seen.

Robot 60, which is designed in particular as a robot arm, is arranged outside work area 31 in an automation cabin 61. In this exemplary embodiment, automation cabin 61 and robot 60 are carried by an add-on module 80 arranged on machine bed 10, which extends the X-axis or the rail system that defines it, in particular, as can be deduced from the position of workpiece spindle 20 shown in the workpiece changing position and T-slot table 22 carrying it, and carriage 23.

Palletizing system 70 is located on the side of robot 60 opposite T-slot table 22. Accordingly, robot 60 can deposit machined workpieces 100 in palletizing system 70 with a simple pivoting movement, grip a new workpiece blank to continue machining and feed it to workpiece spindle 20 without reaching into work area 31. It is particularly advantageous if the movement of robot 60 is designed in such a way that robot 60 is pre-positioned with its workpiece gripper in such a way that, when finished workpiece 100 is transferred, carriage 23 moves a section of workpiece 100 still held in workpiece holder 21 into the opened workpiece gripper of robot 60, which then grips it before it is released and when the next workpiece blank is transferred to workpiece spindle 20, carriage 23 moves a section of workpiece 100 still held in the workpiece gripper of robot 60 into open workpiece holder 21 of workpiece spindle 20, which then fixes it, with an expansion chuck, for example, before the workpiece gripper of robot 60 lets go. Since the movement of carriage 23 along the X-axis is faster and more precisely controlled than that of robot 60, time is not only saved, but transfer errors are also effectively avoided.

FIGS. 1 and 2 show workpiece spindle 20 with workpiece 100 in a machining position in which workpiece 100 can be machined by tool 45. FIGS. 3 to 6 show workpiece spindle 20 with workpiece 100 in a changing position in which robot 60 can remove machined workpiece 100 and insert a new workpiece 100 to be machined.

A wall 36 is arranged between cabin 30 and automation cabin 61, which separates the interior spaces of cabin 30 and automation cabin 61 from one another. Wall 36 only has a closable hatch 35, through which in particular the X-axes runs so that the tool change can take place through hatch 35 by moving tool spindle 20 along the X-axis to the automation cabin 61 and into it, in particular through hatch 35 so that robot 60 does not reach into work area 31 when changing the workpiece.

Grinding machine 1 has a light barrier 90 with a transmitter 91 and a receiver 92, with which the unclamping length of workpiece 100 in workpiece spindle 20 can be carried out when workpiece spindle 20 is moved back from automation cabin 61 after the workpiece change. For this purpose, light barrier 90 is arranged on the X-axis, in particular in such a way that a light beam of light barrier 90 crosses the X-axis. Transmitter 91 and receiver 92 are in particular arranged on opposite sides of the X-axis. The positions of transmitter 91 and receiver 92 shown in the figures can of course be swapped.

The unclamping length is determined by inserting workpiece 100 into workpiece spindle 20 during the workpiece change in such a way that workpiece 100 inserted into workpiece spindle 20 interrupts light barrier 90 in the changing position of workpiece spindle 20. An interruption occurs because workpiece 100 is arranged between transmitter 91 and receiver 92 and no signal from transmitter 91 can be detected by receiver 92 (see FIGS. 3 to 6). The changing position is detected in particular by detecting the position of carriage 23 along the X-axis using the direct, absolute measuring system. When workpiece spindle 20 is moved back, it is determined at which position of workpiece spindle 20, in particular of carriage 23 along the X-axis, light barrier 90 is no longer interrupted, i.e., a signal is detected in receiver 92. This position is then set in relation to the position of workpiece spindle 20 in the changing position, whereby—if necessary taking into account the relative position between workpiece spindle 20 and light barrier 90 in the changing position—the unclamping length of workpiece 100 is determined in this way. This therefore takes place directly on the feed path of workpiece 100, so that time-consuming measurement of workpiece 100 at the machining position (see FIGS. 1 and 2) of workpiece spindle 20 can be omitted.

When changing a workpiece, it can be monitored whether workpiece 100 inserted into workpiece spindle 20 interrupts light barrier 90 in the changing position, and an alarm signal can be output if light barrier 90 is not interrupted in order to obtain information about whether the workpiece change has been carried out correctly.

Transmitter 91 is designed in particular as a laser in order to be able to enable high measurement accuracy. As can be seen in FIGS. 1 to 6, transmitter 91 and receiver 92 can be arranged on a measuring bridge 94. In this way, transmitter 91 and receiver 92 can be fixed relative to one another and light barrier 90 can be installed in a simple manner. It is possible that transmitter 91 and receiver 92 are arranged to be displaceable on measuring bridge 94 in order to be able to carry out a fine adjustment of transmitter 91 and receiver 92 relative to one another if necessary. Measuring bridge 94 is in particular U-shaped and encloses the X-axis, so that transmitter 91 and receiver 92 are arranged on different sides of the X-axis, and in particular of workpiece 100. Measuring bridge 94 is arranged in particular on wall 36 between cabin 30 and automation cabin 61, in particular within automation cabin 61 (see in particular FIGS. 2, 4, 5 and 6). Measuring bridge 94 can be arranged to be displaceable in the direction perpendicular to the X-axis, in particular with respect to height, in order to be able to adjust it in a simple manner in case of different geometries of workpiece 100, if necessary.

It is possible that a second receiver 92 is arranged next to transmitter 92 on the side of transmitter 91 in order to detect the laser beam reflected on workpiece 100 and in this way, in particular by determining the transit time of the laser beam from transmitter 91 to workpiece 100 and back to second receiver 92 and, for example, converting this value into a length value, which is subtracted from the distance between the axis of rotation of tool spindle 20 and transmitter 91, to be able to detect other geometric features of workpiece 100 such as, for example, the diameter or width of workpiece 100, when moving back workpiece spindle 20 on the feed path of workpiece 100.

### LIST OF REFERENCE NUMERALS

1 grinding machine
10 machine bed
20 workpiece spindle
21 workpiece holder
22 T-slot table
23 carriage
24 cover
30 cabin
31 work area
35 hatch
36 wall
40 tool spindle
41 tool holder
42 carriage
43 carriage
44 cover
45 tool
46 cover
50 tool changers
51 carrier plate
52 gripper
60 robot
61 automation cabin
70 palletizing system
80 add-on module
90 light barrier
91 transmitter
92 receiver
94 measuring bridge
100 workpiece

1. A grinding machine (1) with a machine bed (10), on which a workpiece spindle (20) with a workpiece holder (21) and a tool spindle (40) with a tool holder (41) are arranged in such a way that a workpiece (100) held in the workpiece spindle (20), relative to a tool (45) held in the tool holder (40) is
displaceable along an X-axis, which is an axis running in a first direction parallel to the surface of the machine bed (10),
displaceable along a Y-axis, which is an axis running in a second direction parallel to the surface of the machine bed (10),
displaceable along a Z-axis, which is an axis running perpendicular to the surface of the machine bed (10),
rotatable about an A-axis, which is an axis running parallel to the surface of the machine bed (10), and
rotatable about a C-axis, which is an axis running perpendicular to the surface of the machine bed (10),
wherein a cabin (30) is arranged on the machine bed (10), which defines a work area (31), in which in particular the tool spindle (40) and the workpiece spindle (20) are arranged for machining workpieces (100),
wherein the grinding machine (1) has a robot (60) for changing workpieces, which is arranged outside the work area (31) in an automation cabin (61), wherein, for a tool change, the workpiece spindle (20) can be moved on the X-axis to the automation cabin (61) or into the automation cabin (61) so that the robot (60) does not reach into the work area (31) when changing the workpiece,
characterized in that the grinding machine (1) has a light barrier (90) with a transmitter (91) and at least one receiver (92) for determining the unclamping length of the workpiece (100) in the workpiece spindle (20) when the workpiece spindle (20) is moved back from the automation cabin (61) after the workpiece change.

2. The grinding machine according to claim 1,
characterized in that the transmitter (91) is designed as a laser.

3. The grinding machine according to claim 1,
characterized in that the transmitter (91) and the receiver (92) are arranged on a measuring bridge (94) which encloses the X-axis.

4. The grinding machine according to claim 1,
characterized in that the measuring bridge (94) is arranged to be displaceable in the direction perpendicular to the X-axis.

5. The grinding machine according claim 1,
characterized in that the grinding machine (1) comprises means for electro-optical distance measurement and/or geometric measurement.

6. The grinding machine according to claim 1,
characterized in that the light barrier (90) has two receivers (92).

7. The grinding machine according to claim 1,
characterized in that the X-axis is guided through a closable hatch (35) between the cabin (30) and the automation cabin (61), and the measuring bridge (94) is arranged on the wall (36) between the cabin (30) and the automation cabin (61), in particular within the automation cabin (61).

8. The grinding machine according to claim 1,
characterized in that the tool spindle (40) is completely kinematically separated from the workpiece spindle (20), with movements along the X-axis, about the A-axis and about the C-axis are carried out by the workpiece spindle (20), and movements along the Y-axis and along the Z-axis are carried out by the tool spindle (40).

9. The grinding machine according to claim 1,
characterized in that an add-on module (80) is arranged on the machine bed (10), which extends the X-axis and carries the automation cabin (61).

10. The grinding machine according to claim 1,
characterized in that, adjacent to the automation cabin (61), there is a palletizing system (70) or a pallet storage.

11. A method for operating a grinding machine (1) according to claim 1, in which workpieces (100) clamped successively at the workpiece spindle (20) are machined by grinding with one or more tools (45) clamped at the tool spindle (40),
wherein a workpiece change is carried out with a robot (60) arranged outside the work area (31) in an automation cabin (61) by moving the workpiece spindle (20) with the workpiece holder (21) along the X-axis to the automation cabin (61) or into the automation cabin (61),
characterized in that, after the workpiece change, when the workpiece spindle (20) is moved back from the automation cabin (61), the unclamping length of the workpiece (100) in the workpiece spindle (20) is determined by means of a light barrier (90) with a transmitter (91) and a receiver (92) by
inserting, when changing the workpiece, the workpiece (100) into the workpiece spindle (20) in such a way that in a change position the workpiece (100) inserted into the workpiece spindle (20) interrupts the light barrier (90),
determining, when the workpiece spindle (20) is moved back, at which position of the workpiece spindle (20) the light barrier (90) is no longer interrupted
and setting this position in relation to the position of the workpiece spindle (20) in the changing position.

12. The method according to claim 11,
characterized in that, after the workpiece change, in particular when the workpiece spindle (20) is moved back from the automation cabin (61), an electro-optical distance measurement and/or geometric measurement is carried out.

13. The method according to claim 11,
characterized in that, after the workpiece change, when the workpiece spindle (20) is moved back from the automation cabin (61), a further geometric feature of the workpiece (100) is determined by means of the light barrier (90) by determining the transit time, the phase position and/or the angle of the laser beam reflected on the workpiece (100) when the light barrier (90) is interrupted by the workpiece (100).

14. The method according to claim 11,
characterized in that when changing the workpiece, it is monitored whether the workpiece (100) inserted into the workpiece spindle (20) interrupts the light barrier (90) by the workpiece (100) in the changing position, and an alarm signal or an error message is output if the light barrier (90) is not interrupted.

15. The method according to claim 11,
characterized in that in order to carry out a workpiece change and/or to carry out a tool change, the workpiece spindle (20) and/or the tool spindle (40) are moved kinematically decoupled from one another.

16. The method according to claim 11,
characterized in that, when the next workpiece (100) to be machined is picked up, the movement in the direction of the X-axis needed for removing the workpiece (100) from the workpiece holder (21) of the workpiece spindle (20) and/or for inserting the next workpiece into the tool holder (21) of the workpiece spindle (20) takes place by moving the workpiece spindle (20) along the X-axis.
